(19) United States
(12) Patent Application Publication
(10) Pub. No.: US 2019/0130413 A1
(43) Pub. Date: May 2, 2019

(54) SERVICE TICKET ASSIGNMENT AND COLLABORATION

(71) Applicants: BRUCE NELSON, Braselton, GA (US); NAUSHAD ALLI, Buford, GA (US); JASON ROBERTS, Dacula, GA (US)

(72) Inventors: BRUCE NELSON, Braselton, GA (US); NAUSHAD ALLI, Buford, GA (US); JASON ROBERTS, Dacula, GA (US)

(73) Assignee: RICOH COMPANY, LTD., Tokyo (JP)

(21) Appl. No.: 15/797,235

(22) Filed: Oct. 30, 2017

(51) Int. Cl. G06Q 30/00; G06Q 30/02; G06Q 10/10; G06F 17/30

(52) U.S. Cl. CPC G06Q 30/016; G06Q 30/02; G06F 17/30554; G06F 17/30412; G06Q 10/103

(57) ABSTRACT

In an embodiment, a computer-implemented method comprises receiving data from a first client device at a ticketing and reporting system; using the ticketing and reporting system, generating an unassigned ticket using the data received from the first client device; generating and displaying, using a display of a second client device, the unassigned ticket to an agent; using the display, receiving input from the agent selecting the unassigned ticket; and, in response to receiving input, assigning the ticket to the agent and storing assignment information in a database.

### FIELD OF THE INVENTION

The technical field of the present disclosure relates to improved methods, systems, computer software, and/or computer hardware in the field of service ticket assignment and collaboration. The disclosure relates more specifically to improved computer-implemented methods and systems for assigning and collaborating on customer service tickets.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Technicians dispatched in the field to repair or maintain products or parts often require additional assistance from product specialists or agents. In some approaches, technicians contact an agent by calling an automated phone system and inputting information using interactive voice response (IVR) to create a service ticket, also referred to herein as a “ticket.” The automated phone system then selects an agent based on the information entered and connects the technician to the selected agent for ticket handling.

However, having the automated phone system select the agent often results in inappropriate assignments where a selected agent is unable to help the technician. Furthermore, in some approaches, the system is designed such that only a single agent works on a ticket at any given time, which also creates difficulties when any one agent is completely or partially unfamiliar with the product or technology. These issues cause transferred calls to other agents, excessive wait times, and ticket escalations that waste computer system processing resources.

### SUMMARY

The appended claims may serve as a summary of the invention. In an embodiment, a computer-implemented method comprises receiving data from a first client device at a ticketing and reporting system. The method further comprises, using the ticketing and reporting system, generating an unassigned ticket using the data received from the first client device, and generating and displaying, using a display of a second client device, the unassigned ticket to an agent. The method further comprises, using the display, receiving input from the agent selecting the unassigned ticket, and in response to receiving input, assigning the ticket to the agent and storing assignment information in a database. In another embodiment, the method further comprises, in response to assigning the ticket to the agent, displaying a collaboration option in association with the ticket, receiving input selecting the collaboration option, assigning the ticket to one or more collaborating agents, and storing collaboration assignment information in the database. In another embodiment, the method further comprises, using the assignment information stored in the database, generating and displaying a history of tickets previously selected by and assigned to the agent, wherein the history comprises one or more specialty fields associated with each ticket of the history of tickets.

### BRIEF DESCRIPTION OF THE DRAWINGS

The present invention is illustrated by way of example, and not by way of limitation, in the figures of the accompanying drawings and in which like reference numerals refer to similar elements.

FIG. 1 depicts a networked computer system.

FIG. 2 depicts an example client device display displaying features of a technical support application.

FIG. 3 depicts an example client device display displaying features of a ticket management application.

FIG. 4A is a flow diagram that depicts a method or algorithm for assigning tickets.

FIG. 4B is a flow diagram that depicts a method or algorithm for collaborating on tickets.

FIG. 5 is a block diagram that depicts an example computer system upon which embodiments may be implemented.

### DETAILED DESCRIPTION

In the following description, for the purposes of explanation, numerous specific details are set forth in order to provide a thorough understanding of the embodiments. It will be apparent, however, to one skilled in the art that the embodiments may be practiced without these specific details. In other instances, well-known structures and devices are shown in block diagram form in order to avoid unnecessarily obscuring the embodiments.

I. GENERAL OVERVIEW

II. SYSTEM ARCHITECTURE
A. Field Services
B. Network
C. Ticketing System

III. FUNCTIONAL OVERVIEW
A. Field Services Client Device Display
B. Ticketing System Client Device Display

IV. PROCEDURAL OVERVIEW

V. IMPLEMENTATION MECHANISMS

### I. General Overview

According to various embodiments, computer-implemented methods and systems are provided that enable improved accuracy of ticket assignments and improved ticket resolution rates using a collaborative system. The collaborative system enables agents to assess and select which tickets to work on and resolve, either individually or collaboratively. Technical benefits include improved computer and system efficiency by decreasing the excessive use of network bandwidth and decreasing the use of processing resources, such as CPU usage. As a result of this increase in computer and system efficiency, customer satisfaction and resolution rates for tickets increase.

### II. System Architecture

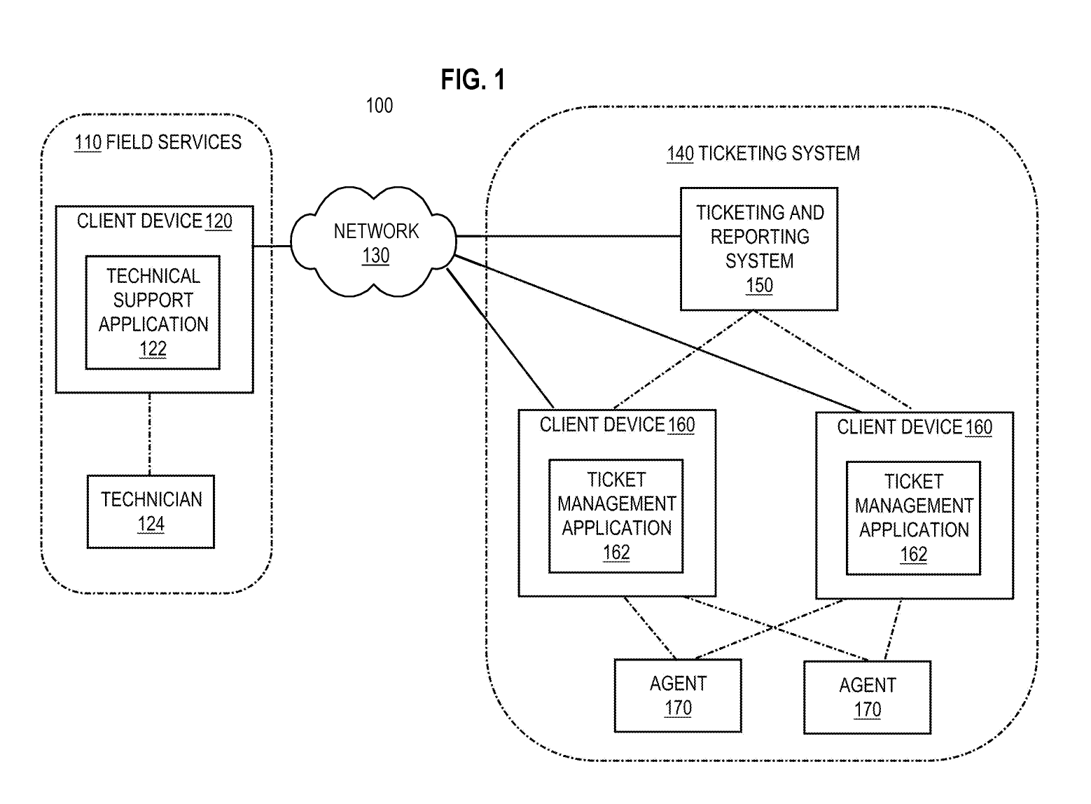

FIG. 1 depicts a networked computer system 100. In an embodiment, the computer system 100 comprises components that are implemented at least partially by hardware at one or more computing devices, such as one or more hardware processors executing program instructions stored in one or more memories for performing the functions that are described herein. All functions described herein are intended to indicate operations that are performed using programming in a special-purpose computer or general-purpose computer, in various embodiments. A “computer” or “computing device” may be one or more physical computers, virtual computers, and/or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, and/or any other special-purpose computing devices. Any reference to “a computer” or “a computing device” herein may mean one or more computers, unless expressly stated otherwise. The instructions identified above are executable instructions and may comprise one or more executable files or programs that have been compiled or otherwise built based upon source code prepared in JAVA, C++, OBJECTIVE-C or any other suitable programming environment.

FIG. 1 depicts only one of many possible arrangements of components configured to execute the programming described herein. Other arrangements may include fewer or different components, and the division of work between the components may vary depending on the arrangement. In the example of FIG. 1, a networked computer system 100 may facilitate the secure exchange of data between computing devices providing field services 110 and devices of a ticketing system 140. Therefore, each of elements 110 and 140 of FIG. 1 may represent or be associated with one or more computers that host or execute processes that provide the functions and operations that are described further herein in connection with field services 110 or the ticketing system 140. The networked computer system 100 is not limited the particular elements depicted in FIG. 1 and may include fewer or additional elements depending upon a particular implementation.

A. Field Services

Field services 110 may be technical services provided to customers for particular products or parts. In some embodiments, field services 110 may be provided by a technician 124. In other embodiments, field services 110 may encompass general technical services provided directly to a customer. For example, a client device 120 may be associated with a customer such that a customer may resolve technical issue without a technician 124. While FIG. 1 depicts a single client device 120, any number of client devices 120 may be used by any number of technicians, customers, or any other individual. While dispatched to various field locations, a technician 124 may use a client device 120 to access and display a technical support application 122, in an embodiment. In other embodiments, a customer or any other individual may use a client device 120 to access and display the technical support application 122. The client device 120 may be any type of client device, including but not limited to a workstation, a personal computer, a laptop computer, a tablet computing device, a personal digital assistant, or a smartphone.

Client device 120 may be configured to submit information to the ticketing system 140 over the network 130. In an embodiment, the client device 120 executes a technical support application 122 that enables the technician 124 to login and submit technical support request information. Technical support application 122 may be implemented by any number and types of processes executing on client device 120. For example, the technical support application 122 may be a web browser configured to access a web-based portal or website that is hosted on a remote server. A field technician 124 may use the technical support application 122 to login to the web-based portal or website and submit technical support request information over a network to generate a ticket. In another embodiment, the technical support application 122 may be a specialized software application installed locally on the client device 120 that is configured to submit technical support request information to a remote server over a network to generate a ticket.

In some embodiments, the technical support application 122 may be a chat application that enables a field technician 124 to send a chat message to an agent 170. In an embodiment, a web-based portal or website may be configured with a chat feature that may be accessed through a web browser installed on the client device 120. The chat feature may be configured to generate a ticket based on the technical support information that is provided by the technician 124 through chat messages. In another embodiment, the technical support application 122 may be a specialized chat application installed locally on the client device 120 that is configured to submit chat messages to agents 170. In an embodiment, the agent 170 who receives the chat may request additional information through the chat application to generate a ticket.

In some embodiments, if the technician 124 does not have internet access for submitting the technical support request information, the technician 124 may contact the customer care organization through a phone call or any other means of contact. The customer care representative may then transcribe the technician 124's information into the technical support application 122 on behalf of the technician 124.

In some embodiments, if the technician 124 has a simple inquiry that does not require extensive content, the technician 124 may use the client device 120 and send a text or picture message via a Short Message Service (SMS) or Multimedia Messaging Service (MMS) network. For example, a technician 124 that merely needs a confirmation of information that requires less than 168 characters may use their client device 120 and send a text message using an SMS or MMS network. The text message may be received and processed by a SMS or MMS portal dedicated to responding to all text messages. The SMS or MMS portal may display the text or picture message to an agent 170, and the agent 170 may then use a client device 160 to send a text or picture message in response.

In some embodiments, social media may be used to facilitate communication between a technician 124 and an agent 170. For example, a technician 124 may use their own social media account to follow a customer service account. An agent 170 may, for example, post an update on the social media site using the customer service account. The update may be pushed directly to the technician 124 who follows the customer service account.

B. Network

Network 130 broadly represents any number and type of wired or wireless networks, such as a combination of one or more local area networks (LANs), wide area networks (WANs), global interconnected internetworks, such as the public Internet, or a combination thereof. Each such network may use or execute stored programs that implement internetworking protocols according to standards such as the Open Systems Interconnect (OSI) multi-layer networking model, including but not limited to TCP or UDP, IP, HTTP, and so forth. All computers described herein may be configured to connect to the network 130 and the disclosure presumes that all elements of FIG. 1 are communicatively coupled via network 130. The various elements depicted in FIG. 1 may also communicate with each other via direct communications links that are not depicted in FIG. 1 for purposes of explanation.

C. Ticketing System

Ticketing system 140 is a system for processing, reporting, and managing tickets based on the technical support request information received from a technician 124 providing field services 110. Embodiments are depicted in the figures and described herein in the context of a single ticketing system 140 for purposes of explanation, but any number of ticketing systems 140 may be used. The ticketing system 140 may feature a ticketing and reporting system 150, a client device 160, and an agent 170. The ticketing and reporting system 150 may be, for example, one or more servers configured to receive technical support request information submitted using the technical support application 122 and process the information to generate one or more tickets. The received technical support request information submitted and the generated tickets may be stored in one or more databases associated with the servers. Subsequently, the stored tickets may be displayed on a client device 160 and managed using a ticket management application 162. In an embodiment, the client device 160 may be any type of client device 160 or a combination of client devices, including but not limited to a display screen, a workstation, a personal computer, a laptop computer, a tablet computing device, a personal digital assistant, or a smartphone. Although embodiments are depicted in the figures and described herein in the context of two client devices 160, embodiments are not limited to this example and any number of client devices may be used.

In another embodiment, the client device 160 may be an interactive whiteboard appliance, which is an electronic whiteboard that supports interactive electronic whiteboard sessions and videoconferencing sessions with other devices. The interactive whiteboard appliance may include the capability to manage interactive electronic whiteboard sessions and videoconferencing sessions in a user-friendly manner by maintaining a videoconferencing session window on top of an interactive whiteboard session window during videoconferencing sessions. The interactive whiteboard appliance may also provide graphical user interface controls that allow users to initiate and manage interactive electronic whiteboard sessions and videoconferencing sessions, including switching between interactive electronic whiteboard sessions and videoconferencing sessions.

The client device 160 may execute a ticket management application 162, which allows an agent 170 to manage, assign, and collaborate on one or more tickets. In an embodiment, the ticket management application 162 may feature unassigned tickets and the technical area of expertise or specialty field that the unassigned ticket pertains to. The unassigned tickets may be displayed in conjunction with the specialty field through a display of the client device 160, which allows an agent 170 to evaluate which unassigned ticket to select. Subsequently, the agent 170 may self-assign a particular unassigned ticket to handle by selecting the unassigned ticket, in an embodiment.

### III. Functional Overview

Each device in the networked computer system 100 may feature a graphical user interface (GUI) with controls that visually present options to users. In some embodiments, the GUI may enable users to input and submit information from a client device to generate a ticket. In other embodiments, the GUI may enable users to view, interact with, assign, collaborate on, and manage tickets. Additional details of the GUI controls are described herein.

A. Field Services Client Device Display

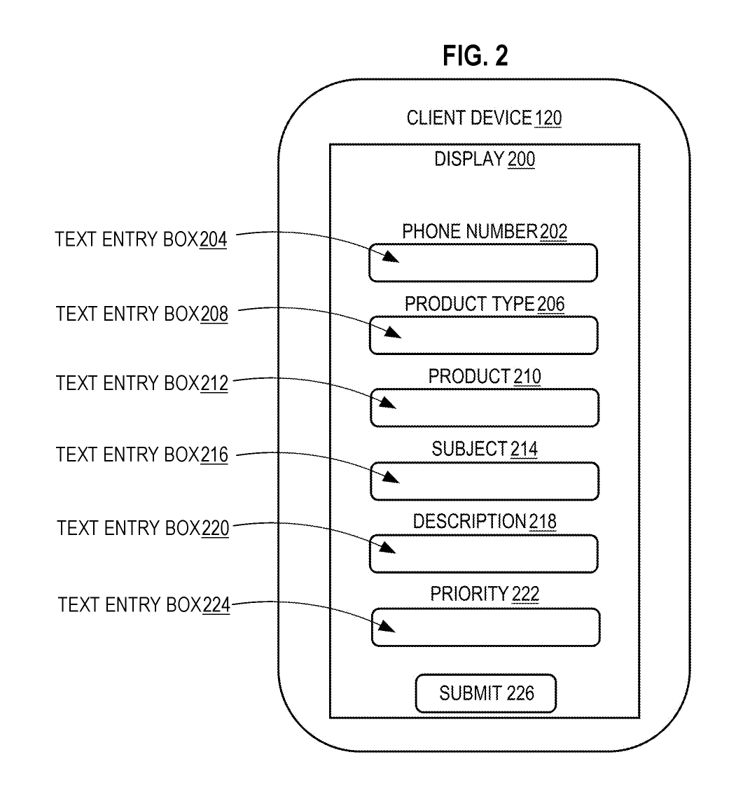

FIG. 2 depicts an example client device display 200 displaying features of a technical support application, in an embodiment. In the example of FIG. 2, a technician 124 in the field may use a client device 120 to access a technical support application 122. In an embodiment, the technical support application 122 may cause the client device 120 to display a variety of information fields and associated text entry boxes.

For example, in FIG. 2, the requested information field for a phone number 202 is associated with a text entry box 204 for entering in a phone number at which the technician 124 may be reached. The information fields for product type 206, product 210, subject 214, description 218, and priority 222 may be associated with text entry box 208, 212, 216, 220, 224, respectively. The product type 206 may refer to a broad type of product, such as software or hardware, while the product 210 may refer to a specific product, such as a printer model number. The subject 214 may refer to the issue or problem that needs to be addressed. In an embodiment, the subject 214 may be the specialty field that an agent 170 later uses to determine ticket assignment. The description 218 may refer to a detailed description of the issue or problem to be resolved. In an embodiment, the description 218 may be the specialty field that an agent 170 later uses to determine ticket assignment.

In an embodiment, the technical support application 122 may also cause the client device 120 to display a submit control 226. The technician 124 may enter all the necessary information into the respective text entry boxes and select the submit control 226. Selection of the submit control causes the technical support application 122 to send the information over the network 130 to the ticketing system 140 for ticket generation and reporting.

B. Ticketing System Client Device Display

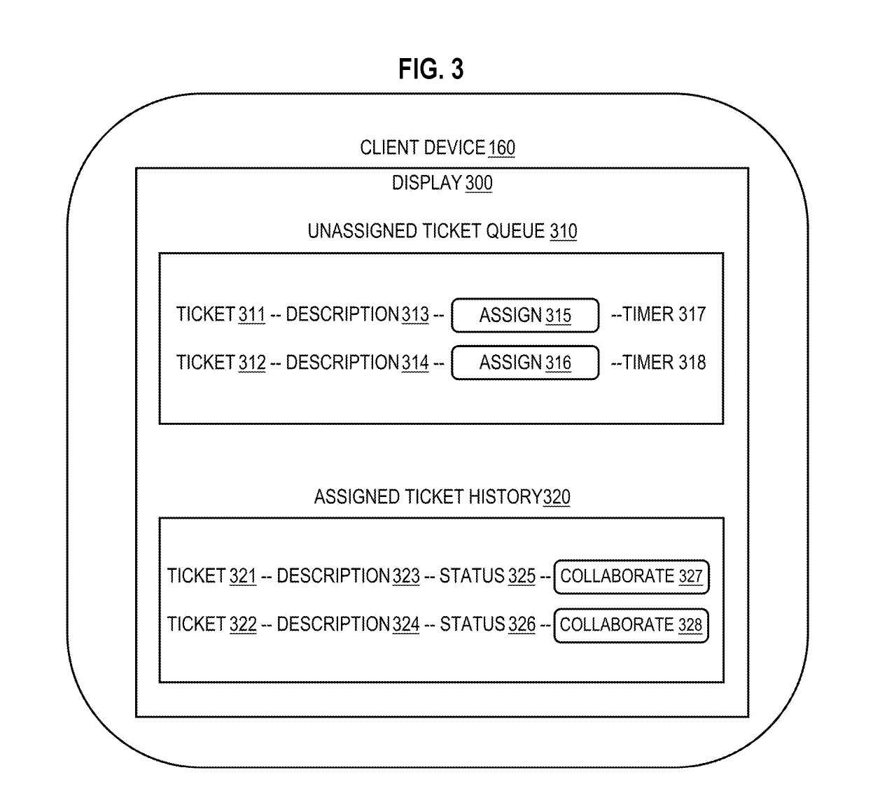

FIG. 3 depicts an example client device display 300 displaying features of a ticket management application, in an embodiment. While FIG. 3 depicts a single embodiment of a client device 160, any number of client devices may be used by any number of agents. The client device 160 may be a single device shared by multiple agents, multiple client devices used by individual agents, or any combination thereof. For example, the client device 160 may be a single large interactive whiteboard appliance, or any other client device 160, that may execute the ticket management application 162. In an embodiment, this client device 160 may be shared by ten to thirty agents in a cubical-free collaborative work space. The client device 160 may also be, for example, a combination of a single non-interactive display, located in a collaborative work space, that works in conjunction with multiple other client devices, such as interactive whiteboard appliances or laptops, that may execute the ticket management application 162.

The ticket management application 162 may use information received and stored at the ticketing and reporting system 150 and provide GUI controls to users. The GUI controls may visually present and allow users to interact with, assign, and manage tickets.

In the example of FIG. 3, a client device 160 has a display 300 that is configured to display an unassigned ticket queue 310. In an embodiment, the display 300 may be configured with a ten (10) second screen refresh rate to ensure that accurate information is displayed. However, any refresh rate may be used. The unassigned ticket queue 310 may be a list of one or more tickets that have not yet been assigned to agents for resolution. In the example of FIG. 3, a ticket 311, 312 is listed under the unassigned ticket queue 310 to indicate that a ticket 311, 312 have not yet been assigned to an agent 170. The ticket 311, 312 may be, for example, a ticket or case number that has been assigned by the ticketing and reporting system 150.

The unassigned ticket queue 310 may also feature a respective description 313, 314 associated with each ticket 311, 312. The description 313, 314 may indicate, for example, the subject matter or specialty field that the associated ticket 311, 312 pertains to. For example, a ticket 311 may pertain to a specialty field of printer installations, which would be featured in the associated description 313. As another example, ticket 312 may pertain to a specialty field of network switching, which would be featured in the associated description 314. Listing the specialty field, or any other description, may help an agent 170 identify which ticket the agent 170 is most qualified to handle. Ticket 311, 312 and description 313, 314 may be user-selectable to display more detailed information. For example, in response to a user selection of ticket 311, additional information about ticket 311 may be displayed, such as a ticket ID, creation date, pending time, origination, etc. As another example, in response to a user selection of description 313, additional description information may be displayed. In an embodiment, an agent 170 may then self-assign a ticket 311, 312 by selecting an assign control 315, 316 to assign the respective ticket 311, 312 to the agent 170.

In another embodiment, the unassigned ticket queue 310 may feature a timer 317, 318. The timer 317, 318 may indicate an elapsed time between when the respective ticket 311, 312 was generated and the current time in order to track how long a ticket 311, 312 has remained unassigned. In some embodiments, the timer 317, 318 may be a countdown timer that designates a certain amount of time that remains before an assignment should be made. In an embodiment, the unassigned ticket queue 310 may be organized in ascending or descending order based the timer 317, 318.

In another embodiment, the timer 317, 318 may feature a warning system that alerts users that a certain amount of time has elapsed without a ticket assignment. For example, if the timer 317 indicates that a ticket 311 has remained unassigned for five (5) minutes, ten (10) minutes, or any other period of time, a warning indicator may be generated and displayed so that an agent 170 may be visually alerted to which unassigned tickets need to be assigned. In an embodiment, the warning indicator may be a change in color in the timer 317, 318, a flashing timer 317, 318, a dialog box featuring a warning, or any other indicator or combination of indicators. Subsequently, in the example above, an agent 170 may self-assign the ticket 311 by selecting the assign control 315. Upon selection of any assign control 315, 316, the timer 317, 318 may stop and record the total elapsed time between when the ticket 311, 312 was generated and when the ticket 311, 312 was assigned. This may allow the tracking of assignment times for improved customer service.

In an embodiment where the client device 160 is a single interactive whiteboard appliance, the GUI may be configured to enable an agent 170 to select the assign control 315, 316 to generate and display a menu of agent names. Selecting a name from the menu of agent names may assign the ticket 311, 312 to the selected agent 170. In another embodiment where the client device 160 is a single large display and control of ticket assignments is regulated by multiple laptops used by each agent 170, each agent 170 may be signed in to an agent account such that selecting the assign control 315, 316 automatically assigns the respective ticket 311, 312 to the particular agent 170 who selects the assign control 315, 316.

In an embodiment, the display 300 may also be configured to display an assigned ticket history 320. The assigned ticket history 320 may be a list of one or more tickets that have already been assigned to agents for resolution. While the assigned ticket history 320 is displayed below the unassigned ticket queue 310 in the example of FIG. 3, the assigned ticket history 320 may be displayed in any location. In an embodiment, the assigned ticket history 320 is fixed in the display, while in another embodiment, it may be hidden and automatically displayed upon selection of an assign control 315, 316. In yet another embodiment, the assigned ticket history 320 may be hidden until an agent 170 selects an option to view the assigned ticket history 320.

In the example of FIG. 3, the assigned ticket history 320 may feature an assigned ticket 321, 322, a description 323, 324 associated with the respective ticket 321, 322, a status 325, 326 associated with the respective ticket 321, 322, and a collaborate control 337, 338 associated with the respective ticket 321, 322. In an embodiment where the client device 160 is a single interactive whiteboard appliance, the GUI may also be configured to display a collective assigned ticket history 320 of all agents in the department, as well as the name of the agent 170 currently assigned to handle a respective ticket 321, 322. In another embodiment where the client device 160 is a single large display and ticket assignments are designated by using other client devices associated with each agent 170, the assigned ticket history 320 may be linked to an agent account such that the assigned ticket history 320 is a history specific to the particular agent 170 that is associated with the agent account.

In the example of FIG. 3, the assigned ticket history 320 may feature an assigned ticket 321, 322. The assigned ticket 321, 322 may be, for example, a ticket number that has been designated by the ticketing and reporting system 150 for subsequent use in identifying the matter. The assigned ticket history 320 may also feature a respective description 323, 324 associated with each ticket 321, 322. The description 323, 324 may indicate, for example, the subject matter or specialty field that the associated ticket 321, 322 pertains to. For example, a ticket 321 may pertain to a specialty field of printer network connectivity, which would be featured in the associated description 323. A different ticket 322 may pertain to a specialty field of, for example, printer parts repair, which would be featured in the associated description 314.

The assigned ticket history 320 may also feature a respective status 325, 326 associated with each ticket 321, 322. The status 325, 326 may be, for example, a pending ticket status, a completed ticket status, or a follow-up ticket status, although any number or combination of statuses may be used. The pending ticket status may indicate that the ticket is currently being handled. The completed ticket status may indicate that the ticket has been resolved. The follow-up status may indicate that a ticket should be followed up with. In an embodiment, the status 325, 326 may be color-coded for easy identification. For example, a pending ticket status may be green, a completed ticket status may be red, and a follow-up ticket status may be yellow. However, any color may be used to represent any status. Similar to the unassigned ticket queue 310, information displayed in the assigned ticket history 320, such as ticket 321, 322, description 323, 324, and status 325, 326 may be user-selectable to provide additional information. For example, status 325, 326 may be changed from pending to resolved with user input. In addition, the status 325, 326 may specify one or more agents assigned to the ticket 321, 322, for example, by name, employee ID, etc., and may include a facial image or other identifying information for each agent.

In an embodiment, the list of tickets featured in the assigned ticket history 320 may be organized by ticket, description, status, or collaborating agents. For example, the ticket management application 162 may be configured to display options for listing the tickets in ascending or descending order based on the ticket number. In another embodiment, the options may allow groupings of the tickets based on the description, status, or assigned and collaborating agents.

In some embodiments, the ticketing and reporting system 150 may be configured with algorithms that store and aggregate the ticket history of each agent 170 or of all the agents collectively. In some embodiments, the ticket management application 162 may be configured to display the total number of tickets resolved by each agent. In other embodiments, the ticket management application 162 may be configured to display the quantity of tickets resolved by each agent for each type of specialty field. In such an embodiment, agents with the most resolved tickets in a specialty field may be suggested as potential collaborators on future tickets pertaining to that specialty field. The ticket management application 162 may also display other information for each agent 170, such as statistical information that indicates the amount of time required to resolve each ticket, average resolution time, the number of inquiries required for each ticket, etc. Agents 170 may also be ranked based upon their respective ticket history compared to other agents 170.

The assigned ticket history 320 may also feature a collaborate control 327, 328 associated with a respective ticket 321, 322. The collaborate control 327, 328 may allow an agent 170, who is already assigned to a respective ticket 321, 322, to request collaboration between one or more other collaborating agents to resolve the ticket 321, 322. For example, if an agent 170 who has self-assigned a ticket 321 discovers that they are unable to resolve the issue without additional assistance, the assigned agent 170 may select the collaborate control 327 to request that one or more other agents be assigned as collaborating agents to help resolve the issue.

In an embodiment, the request may be done verbally and in-person while the agents are situated in a collaborative work space. The agents may be located, for example, in a single room with no cubicles that enables uninhibited movement and facilitates collaborative interactions. In the preceding example, the assigned agent 170 may verbally confirm one or more other agents' availability and then select the collaborate control 327. The input received may cause the ticket management application 162 to display a menu that lists other available agents to collaborate with. The assigned agent 170 may then select one or more of the available collaborating agent(s). The selection input received causes the ticket management application 162 to assign the selected agent(s) as collaborating agent(s) for the particular ticket 321 and store the collaboration information.

In another embodiment, the request may be submitted via the display 300. For example, when the collaborate control 327 is selected, the ticket management application 162 may be configured to filter and display only agents that are currently available for collaboration. The availability of an agent 170 may be determined by evaluating whether an agent has an assigned ticket with a pending status, for example. The assigned agent 170 may then select one or more of the available collaborating agent(s).

Additional filtering options may also be provided. For example, the ticket management application 162 may be configured to display a specialty field filtering option which, when selected, shows only a list of agents that have experience with a particular specialty field. This enables an assigned agent 170 to select a collaborating agent 170 who has expertise in the specialty field, and would be more likely to help resolve the ticket. In an embodiment, the ticket management application 162 is configured to automatically filter and display suggested collaborating agents that have previously resolved tickets of the same or similar specialty fields. Any number of other filters and filtering options may be implemented. Moreover, any number of filters and filtering options may be combined. For example, the ticket management application 162 may be configured to filter collaborating agent options for selection based on both an availability of a potential collaborating agent 170 and the specialty field. In an embodiment, the ticket management application 162 may be configured to automatically suggest one or more collaborating agents that have worked on the same or similar product or subject, as determined, for example by the description information, worked on tickets from the same technician, worked with the assigned agent 170, agent availability, specialty field experience, or any other factors, alone or in any combination.

### IV. Procedural Overview

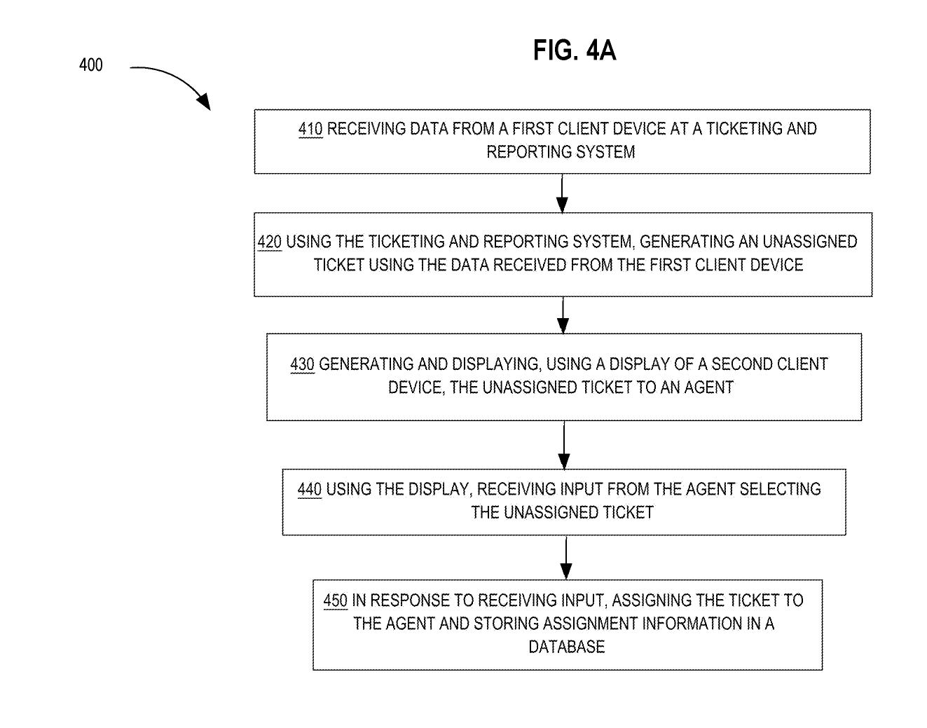

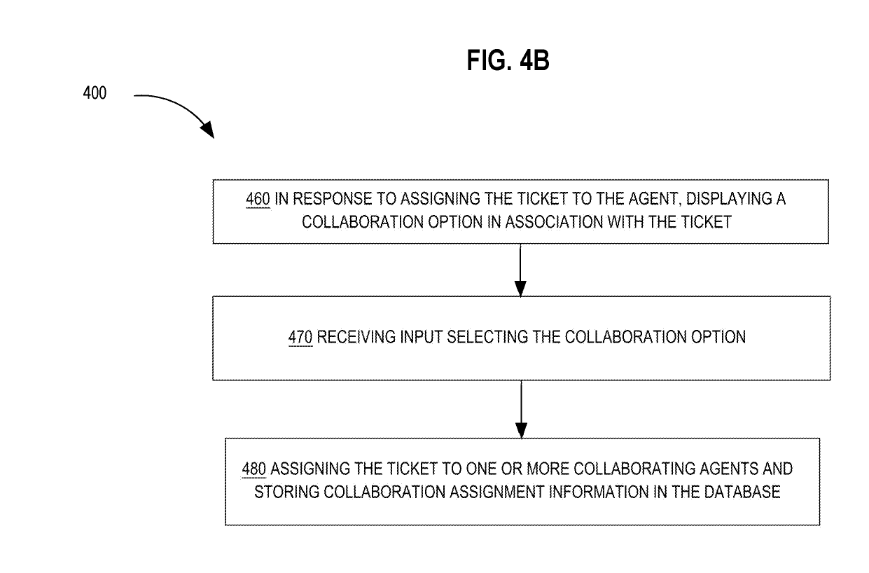

FIG. 4A and FIG. 4B are flow diagrams that depict a method 400 or algorithm for assigning tickets, in an embodiment. The method 400 utilizes a computer system that gives each agent 170 the flexibility to select which ticket to resolve. Moreover, the computer system allows for continuous tracking and storage of tickets and resolution statuses. This facilitates faster and more accurate responses from agents and quicker resolution rates without the need for escalation or additional wait times. The technical benefits include, for example, reducing the number of repeated ticket submissions for the same issue and reducing ticket escalations, thereby reducing the total amount of computational and storage resources required to resolve an issue.

At step 410, the ticketing and reporting system 150 receives data from a first client device. The data received may include information that a technician 124, customer, or any other individual entered into the text entry box 204, 208, 212, 216, 220, 224 of the technical support application 122. This data may pertain to, for example, a phone number 202, a product type 206, a product 210, a subject 214, a description 218, and a priority 222. Any other data, such as a name or email address, may also be received. After the technician 124, customer, or any other individual enters the information at the client device 120 using the technical support application 122 and selects a submit control 226 to send the information, the client device 120 and technical support application 122 may be configured to transmit the data over the network 130 to the ticketing system 140. The ticketing system 140 may be a system for processing, reporting, and managing tickets based on the technical support request information received from a technician 124, customer, or any other individual providing field services 110. The ticketing system 140 may feature a ticketing and reporting system 150, a client device 160, and an agent 170. Specifically, the ticketing and reporting system 150 may be one or more computers configured to receive and store the data for ticket generation.

At step 420, the ticketing and reporting system 150 generates an unassigned ticket using the data received from the first client device. The ticketing and reporting system 150 may, for example, process the data received from the technical support application 122 to generate and store a database of unassigned tickets. These unassigned tickets may be formatted such that a user, such as an agent 170 using a ticket management application 162, may access the unassigned tickets through a GUI.

At step 430, an unassigned ticket is generated and displayed to an agent using a display of a second client device. In an embodiment, an unassigned ticket 311, 312 may be displayed to an agent 170 using a display 300 of a client device 160. The unassigned ticket 311, 312 may be displayed in an unassigned ticket queue 310 with an option to assign the ticket 311, 312 to an agent 170. In an embodiment, one or more agents 170 may be in a cubical-free, collaborative work space with a single communal display 300 that shows the unassigned ticket queue 310. Each agent 170 may view the description 313, 314 of the respective ticket 311, 312 to evaluate the specialty field that the ticket 311, 312 pertains to and decide which ticket the agent 170 is best suited to handle.

In an embodiment, the display 300 and client device 160 is an interactive whiteboard appliance that enables an agent 170 to select the assign control 315, 316 using the interactive display 300. In another embodiment, the display 300 may display the unassigned ticket queue 310, but work in conjunction with separate client devices, such as laptops or interactive whiteboard appliances, that are associated with each agent 170. In such an embodiment, the agent 170 may view the unassigned ticket queue 310 via display 300, determine which ticket 311, 312 to handle, and then use their own laptop or interactive whiteboard appliance with their own agent login to select the assign control 315, 316.

At step 440, an input is received from the agent 170 selecting the unassigned ticket. Any method of receiving input may be used. In an embodiment, the display 300 may be a touch screen that is configured to receive touch input from the agent 170. The client device 160 may also enable an agent 170 to select options using a touchpad, keyboard, mouse or any other method of selection. When the agent 170 selects an assign control 315, 316, the client device 160 and ticket management application 162 may register and record the input. In an embodiment, the input may be sent to the ticketing and reporting system 150. The ticketing and reporting system 150 database may then be updated with the ticket assignment.

In an embodiment where the client device 160 is a single interactive whiteboard appliance, the GUI may be configured to enable an agent 170 to select the assign control 315, 316 to generate and display a menu of agent names. Selecting a name from the menu of agent names may assign the ticket 311, 312 to the selected agent 170. In another embodiment where the client device 160 is a single large display and control of ticket assignments is regulated by multiple other client devices used by each agent 170, each agent 170 may be signed in to an agent account such that selecting the assign control 315, 316 automatically assigns the respective ticket 311, 312 to the particular agent 170 who selects the assign control 315, 316.

In an embodiment, ticket management application 162 may be configured with automatic identification recognition algorithms, such as fingerprint analysis, facial recognition, keycard analysis, device analysis, or any other form of automated identification. The client device 160 may be equipped with hardware, such as a camera or fingerprint scanner, that works in conjunction with the automatic identification recognition algorithms to automatically recognize the agent 170 and associate a particular ticket 311, 312 or a particular action associated with a ticket 311, 312, with that particular agent 170. Subsequently, any input from the agent 170 may be automatically associated with the agent 170. For example, the ticket management application 162 may automatically recognize the identity of an agent 170 and associate the agent 170 with the agent's input selecting an assign control 315, 316.

At step 450, the ticket is assigned to the agent and assignment information is stored in a database in response to receiving selection input. The ticketing and reporting system 150 may receive the selection input and associated identity information of the agent 170 and process and store the input and identity information. For example, the database of unassigned tickets associated with the ticketing and reporting system 150 may be updated as assigned tickets with associated assignment information.

In an embodiment, at step 460, in response to assigning the ticket to the agent 170, a collaboration option is displayed in association with the assigned ticket. For example, the ticket management application 162 may display an assigned ticket history 320 in the display 300, which shows one or more tickets have been assigned to an agent 170. In an embodiment, the assigned ticket history 320 may be generated and displayed using information stored in the database associated with the ticketing and reporting system 150. The assigned ticket 321, 322 may be displayed in association with a respective collaborate control 327, 328 which, if and when selected, causes the ticket management application 162 to display a menu of other agents who can collaborate on the assigned ticket 321, 322. Use of the collaboration option is not required, and the collaboration option may be configured, e.g., activated or deactivated, via ticket management system 162.

Assuming that the collaboration option is active, at step 470, an input selecting the collaboration option is received. Input from either the assigned agent 170 or potential collaborating agents may be received to add collaborators. For example, if the assigned ticket history 320 is specific to the assigned agent 170 where only the assigned agent 170 has access to his or her own assigned ticket history, then the collaborate control 327, 328 may enable the agent 170 to select from a menu of other potential collaborating agents. In another embodiment, the assigned ticket history 320 may be a comprehensive history of every ticket that has been assigned, which displays an agent name or other identifier of the agent assigned to each ticket. In such an example, any agent 170, including potential collaborators may select the collaborate control 327, 328 to assign collaborators.

In an embodiment, the ticket management application 162 may be configured to filter and display agents that are currently available for collaboration. The ticket management application 162 may, for example, be configured to determine whether other agents are currently assisting a field technician 124, customer, or any other individual and display the names of those agents as unavailable for collaboration. In other embodiments, the ticket management application 162 may be configured to filter and display agents with expertise in a particular specialty field. Any number of other filters may be configured and combined. Moreover, these filters may be automatically implemented or displayed as filtering options.

At step 480, the ticket is assigned to one or more collaborating agents and the collaboration assignment information is stored in the database. The selection input received may cause the ticket management application 162, in association with the ticketing and reporting system 150, to assign the selected agent(s) as collaborating agent(s) for the particular ticket and send a notification to the selected collaborating agent(s). The ticketing and reporting system 150 may, for example, receive the selection input and associated identity information of the collaborating agent 170, and process and store the input and identity information. For example, the database of assigned tickets that is associated with the ticketing and reporting system 150 may be updated with associated collaboration assignment information.

The information stored in the ticketing and reporting system 150 database may be used to track and display agent performance and improve customer service. For example, the ticketing and reporting system 150 may aggregate performance information and generate a performance chart or graph that lists and categorizes types of ticket issues, the names of the assigned agent 170, the names of any collaborating agents, the amount of time taken to assign the ticket, the amount of time taken to resolve the ticket, and any other relevant information. Subsequently, the ticket management application 162 may be configured to display the performance chart or graph for evaluation and performance assessment.

In an embodiment, the information stored in the ticketing and reporting system 150 database may be used to send assignment and collaboration information to the client device 120. For example, after one or more agents are assigned to a particular ticket 321, 322, the identity and phone number of the agent may be sent to the technician 124's, customer's, or any other individual's client device 120 to improve the customer service.

After an agent 170 self-assigns a ticket or selects collaborating agents for a ticket, the agent may contact the client device 120 associated with the technician 124, customer, or any other individual and proceed toward a resolution of the ticket. In an embodiment, the ticket management application 162 may be configured to enable an agent 170 to call a technician 124, customer, or any other individual. In an embodiment, the ticket management application 162 may have a white noise feature configured into the application that reduces the background noise of other agents while the agent 170 is on a call with the technician 124, customer, or any other individual.

Once a ticket is resolved, the ticket management application 162 may be configured to mark the ticket 321, 322 as resolved in the ticketing and reporting system 150 database. In an embodiment, the ticket management application 162 may display a resolution control associated with the status 325, 326 that enables an agent to change the status of the ticket to indicate that the ticket 321, 322 has been resolved. A timestamp of when the ticket was resolve may also be included such that the ticketing and reporting system 150 may be used to track resolution speed and improve customer service.

The ticket management application 162 may also report the results to the client device 120 and individual. For example, the ticket management application 162 may be configured to enable an agent 170 to call a technician 124, customer, or any other individual to report the status as resolved. In another embodiment, the ticket management application 162 may be configured to send a completion email to the client device 120 to notify the technician 124, customer, or any other individual that the ticket has been resolved. Where a web-based portal is configured with personalized logins for technicians, the ticket management application 162 may be configured to send an update notification to the web-based portal that notifies the technician 124, customer, or any other individual that the ticket has been resolved. In another embodiment, the ticket management application 162 may also be configured to send a chat message through a chat application or send a text message via an SMS or MMS network. In another embodiment, the ticket management application 162 may also be configured to send a social media message or post a completion status directed to the technician 124, customer, or any other individual to a social media message board.

Using the foregoing techniques, programmed computers may process, store, display, and manage ticket information in an improved ticket assignment and collaboration system that decreases wasteful use of processing resources and increases the efficiency of the overall system. Traditional techniques without the improved techniques described above often result in transferred calls, ticket escalations, and excessive wait times that strain computer system processing resources and network bandwidth. The foregoing techniques provide for an improvement in computer and system efficiency by decreasing the excessive use of network bandwidth and decreasing the use of processing resources, such as CPU usage. For example, the approaches may reduce the number of tickets required to resolve an issue, thereby reducing the amount of computational and storage resources required to resolve an issue. As a result of this increase in computer and system efficiency, customer satisfaction and resolution rates for tickets increase.

### V. Implementation Mechanisms

Although the flow diagrams of the present application depict a particular set of steps in a particular order, other implementations may use fewer or more steps, in the same or different order, than those depicted in the figures.

According to one embodiment of the invention, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

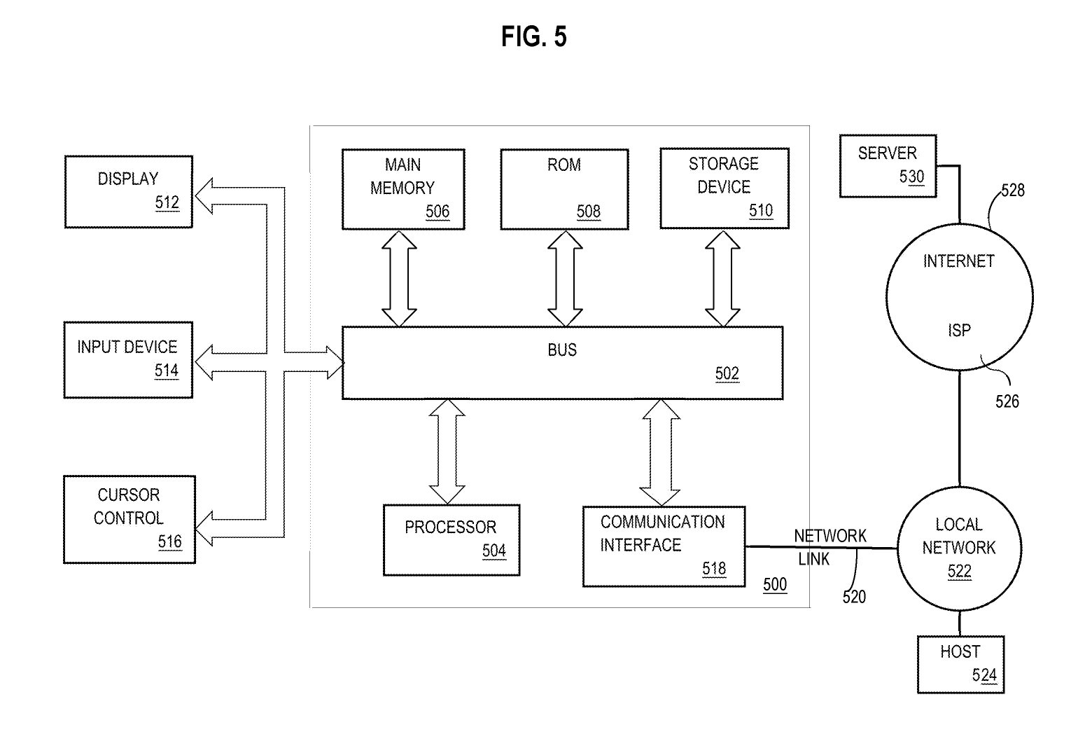

FIG. 5 is a block diagram that depicts an example computer system 500 upon which embodiments of the invention may be implemented. Computer system 500 includes a bus 502 or other communication mechanism for communicating information, and a processor 504 coupled with bus 502 for processing information. Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), liquid crystal display (LCD), or any other display for displaying information to a computer user. Although bus 502 is illustrated as a single bus, bus 502 may comprise one or more buses. For example, bus 502 may include without limitation a control bus by which processor 504 controls other devices within computer system 500, an address bus by which processor 504 specifies memory locations of instructions for execution, or any other type of bus for transferring data or signals between components of computer system 500.

An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic or computer software which, in combination with the computer system, causes or programs computer system 500 to be a special-purpose machine. According to one embodiment of the invention, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing data that causes a computer to operate in a specific manner. In an embodiment implemented using computer system 500, various non-transitory computer-readable media are involved, for example, in providing instructions to processor 504 for execution. Such a medium may take many forms, including but not limited to, non-volatile media and volatile media. Non-volatile media includes, for example, optical or magnetic disks, such as storage device 510. Volatile media includes dynamic memory, such as main memory 506. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An apparatus comprising:
one or more processors; and
one or more memories communicatively coupled to the one or more processors and storing instructions which, when processed by the one or more processors causes:
receiving data from a first client device at a ticketing and reporting system;
using the ticketing and reporting system, generating an unassigned ticket using the data received from the first client device;
generating and displaying, using a display of a second client device, the unassigned ticket to an agent;
using the display, receiving input from the agent selecting the unassigned ticket; and
in response to receiving input, assigning the ticket to the agent and storing assignment information in a database.

2. The apparatus of claim 1, wherein the one or more memories further store additional instructions which, when processed by the one or more processors, cause:
in response to assigning the ticket to the agent, display a collaboration option in association with the ticket;
receive input selecting the collaboration option;
assign the ticket to one or more collaborating agents and store collaboration assignment information in the database.

3. The apparatus of claim 2, wherein the one or more memories further store additional instructions which, when processed by the one or more processors, cause:
in response to storing assignment information in the database, sending the assignment information to the first client device, wherein the assignment information comprises an agent name and contact information; and
in response to storing collaboration assignment information in the database, sending the collaboration assignment information to the first client device, wherein the collaboration assignment information comprises a collaborating agent name and contact information.

4. The apparatus of claim 1, wherein the one or more memories further store additional instructions which, when processed by the one or more processors, cause:
using the assignment information stored in the database, generating and displaying a history of tickets previously selected by and assigned to the agent, wherein the history comprises one or more specialty fields associated with each ticket of the history of tickets.

5. The apparatus of claim 4, wherein the one or more memories further store additional instructions which, when processed by the one or more processors, cause:
generating and displaying a status indicator for each ticket of the history of tickets, wherein the status indicator indicates a pending ticket status, a completed ticket status, or a follow-up ticket status.

6. The apparatus of claim 4, wherein the one or more memories further store additional instructions which, when processed by the one or more processors, cause:
using the assignment information stored in the database, generating and displaying a collaboration recommendation, wherein the collaboration recommendation comprises one or more potential collaborating agents that are recommended based on the one or more specialty fields.

7. One or more non-transitory computer-readable media storing instructions which, when processed by one or more processors, cause:
receiving data from a first client device at a ticketing and reporting system;
using the ticketing and reporting system, generating an unassigned ticket using the data received from the first client device;
generating and displaying, using a display of a second client device, the unassigned ticket to an agent;
using the display, receiving input from the agent selecting the unassigned ticket; and
in response to receiving input, assigning the ticket to the agent and storing assignment information in a database.

8. The one or more non-transitory computer-readable media of claim 7, further comprising additional instructions which, when processed by the one or more processors, cause:
in response to assigning the ticket to the agent, displaying a collaboration option in association with the ticket;
receiving input selecting the collaboration option;
assigning the ticket to one or more collaborating agents and storing collaboration assignment information in the database.

9. The one or more non-transitory computer-readable media of claim 8, further comprising additional instructions which, when processed by the one or more processors, cause:
using the assignment information stored in the database, generating and displaying a history of tickets previously selected by and assigned to the agent, wherein the history comprises one or more specialty fields associated with each ticket of the history of tickets.

10. The one or more non-transitory computer-readable media of claim 9, wherein the history of tickets is organized and displayed based on a status indicator of each ticket or a specialty field of each ticket.

11. The one or more non-transitory computer-readable media of claim 10, further comprising additional instructions which, when processed by the one or more processors, cause:
using the assignment information stored in the database, generating and displaying a collaboration recommendation, wherein the collaboration recommendation comprises one or more potential collaborating agents that are recommended based on specialty fields.

12. The one or more non-transitory computer-readable media of claim 11, further comprising additional instructions which, when processed by the one or more processors, cause:
in response to storing assignment information in the database, sending the assignment information to the first client device, wherein the assignment information comprises an agent name and contact information.

13. The one or more non-transitory computer-readable media of claim 12, further comprising additional instructions which, when processed by the one or more processors, cause:
in response to storing collaboration assignment information in the database, sending the collaboration assignment information to the first client device, wherein the collaboration assignment information comprises a collaborating agent name and contact information.

14. A computer-implemented method, comprising:
receiving data from a first client device at a ticketing and reporting system;
using the ticketing and reporting system, generating an unassigned ticket using the data received from the first client device;
generating and displaying, using a display of a second client device, the unassigned ticket to an agent;
using the display, receiving input from the agent selecting the unassigned ticket; and
in response to receiving input, assigning the ticket to the agent and storing assignment information in a database.

15. The method of claim 14, further comprising:
in response to assigning the ticket to the agent, displaying a collaboration option in association with the ticket;
receiving input selecting the collaboration option;
assigning the ticket to one or more collaborating agents and storing collaboration assignment information in the database.

16. The method of claim 14, further comprising:
in response to storing assignment information in the database, sending the assignment information to the first client device, wherein the assignment information comprises an agent name and contact information.

17. The method of claim 14, wherein the data received from the first client device comprises a specialty field associated with the ticket, and wherein generating and displaying the unassigned ticket comprises generating and displaying the specialty field.

18. The method of claim 14, further comprising:
using the assignment information stored in the database, generating and displaying a history of tickets previously selected by and assigned to the agent, wherein the history comprises one or more specialty fields associated with each ticket of the history of tickets.

19. The method of claim 18, wherein generating and displaying the history of tickets further comprises generating and displaying a status indicator for each ticket of the history of tickets, wherein the status indicator indicates a pending ticket status, a completed ticket status, or a follow-up ticket status.

20. The method of claim 19, wherein generating and displaying the status indicator comprises generating and displaying the pending ticket status in red, the completed ticket status in green, or the follow-up ticket status in yellow.
